(19) United States
(12) Patent Application Publication
(10) Pub. No.: US 2025/0378290 A1
(43) Pub. Date: Dec. 11, 2025

(54) Cordless Top Down Reader

(71) Applicant: ZEBRA TECHNOLOGIES CORPORATION, Lincolnshire, IL (US)

(72) Inventors: Darran Michael Handshaw, Sound Beach, NY (US); Edward Barkan, Miller Place, NY (US); Mark Drzymala, Saint James, NY (US)

(21) Appl. No.: 18/737,921

(22) Filed: Jun. 7, 2024

(51) Int. Cl. G06K 7/10

(52) U.S. Cl. CPC G06K 7/1096; G06K 7/10386

(57) ABSTRACT

A system and methods for a bioptic scanner with a removable synchronized scanner. The system includes a bioptic scanner having a first housing portion with a first imaging assembly having a field of view (FOV) directed toward a product scanning region, a second housing portion with a second imaging assembly with a second FOV directed toward the product scanning region. A removable scanner module is selectively couplable with a scanner cradle coupled with at least one of the first housing portion, second housing portion, or a frame member, the removable scanner module includes at least one supplemental imaging assembly having a supplemental imaging sensor with a supplemental FOV directed toward the product scanning region. A is controller coupled to the bioptic scanner and couplable to the removable scanner configured to synchronize the removable scanner with the bioptic scanner.

### BACKGROUND

Barcode readers are commonly used in retail and grocery store venues to help facilitate various transaction. In particular, bi-optic barcode readers rely on image data captured by one or more image sensors to conduct image analysis and perform various functions based on that analysis. Handheld readers require operation by a user to properly position the reader and to scan items manually. Each types of barcode reader has limited fields of view for capturing images of items and targets to perform scanning and reading barcodes. In light of this, there is a continued need for further development associated with the ability to gather image-based data for bi-optic barcode reader use. Additionally, each type of scanner of barcode reader requires different types of illumination to operate efficiently. Accordingly, there is a need for improved accessories having improved functionalities.

### SUMMARY

Barcode readers and assemblies are disclosed herein that include a bioptic scanner including a housing having a first housing portion with a first surface and a first window facing a product scanning region, and a second housing portion with a second surface and a second window facing the product scanning region. A first imaging assembly is disposed in the first housing portion the first imaging assembly having a first imaging sensor, and a first field of view (FOV) directed through the first window. A second imaging assembly is disposed in the second housing with the second imaging assembly having a second imaging sensor and a second FOV directed through the second window. A removable scanner module is selectively couplable with a scanner cradle that is coupled with at least one of the first housing portion, second housing portion, or a frame member. The removable scanner module includes at least one supplemental imaging assembly having a supplemental imaging sensor with a supplemental FOV directed toward the product scanning region. A controller is operatively coupled to the bioptic scanner and couplable to the removable scanner. The controller is configured to synchronize the removable scanner with the bioptic scanner.

In examples, when coupled with the scanner cradle, the controller synchronizes the removable scanner with the bioptic scanner. In some examples, when coupled with the scanner cradle, the controller synchronizes the removable scanner with at least one of the first imaging assembly and the second imaging assembly to obtain images of the product scanning region.

In some approaches, when coupled with the scanner cradle, the supplemental FOV is directed generally downward intersecting with at least one of the first FOV or second FOV over the product scanning region.

In more examples, when the removable scanner is coupled with the scanner cradle, the scanner cradle is configured to provide power to the removable scanner.

In further examples, when coupled with the scanner cradle, the removable scanner enters a synchronization mode and when decoupled from the scanner cradle, the removable scanner enters an independent operation mode. In some of these examples, in the synchronization mode, the controller synchronizes one or more operations of the removable scanner with the bioptic reader to obtain images of an object disposed in the product scanning region, and in the independent operation mode, the controller does not synchronize the removable scanner with the bioptic reader to obtain images.

In these and other approaches, the removable scanner further includes an illumination assembly adapted to illuminate a portion of the product scanning region when coupled with the scanner cradle. In these and additional examples, the removable scanner further includes a visual indicator adapted to indicate a direction of the supplemental FOV. The visual indicator, in some implementations, may include an aiming system. In further implementations, the aiming system is synchronized with the bioptic scanner to prevent imaging of the visual indicator by the first imaging assembly or the second imaging assembly.

In accordance with a second aspect, an adaptable multi-field of view scanning system includes a bioptic scanner having a housing with a first housing portion with a first surface and a first window facing a product scanning region and a second housing portion with a second surface and a second window facing the product scanning region. A first imaging assembly has a first imaging sensor with the first imaging assembly having a first field of view (FOV) directed through the first window. A second imaging assembly has a second imaging sensor with the second imaging assembly having a second FOV directed through the second window. A removable scanner module is selectively couplable with a scanner cradle coupled with at least one of the first housing portion, second housing portion, or a frame member. The removable scanner module includes at least one supplemental imaging assembly having a supplemental imaging sensor with a supplemental FOV directed toward the product scanning region. When coupled with the scanner cradle, the removable scanner is in synchronization with the bioptic scanner. One or more processors are configured to control a mode of the removable scanner or a device in communication with the removable scanner in response to coupling of the removable scanner with the scanner cradle. A computer-readable storage medium stores computer-readable instructions that, when executed by one or more processors, cause the processor to (i) configure the removable scanner into a synchronize mode when the removable scanner is coupled to the scanner cradle and (ii) configured the removable scanner into an independent operation mode when the removable scanner is not coupled to the scanner cradle.

In implementations, when the removable scanner is in synchronize mode, the computer readable media cause the one or more processors to synchronize the removable scanner with at least one of the first imaging assembly and the second imaging assembly to obtain images of the product scanning region.

In some examples, the removable scanner has a same symbol timeout time, and the computer readable media causes the one or more processors to synchronize the same symbol timeout time of the removable scanner with a same symbol timeout time of the bioptic scanner.

In approaches, when coupled with the scanner cradle, the supplemental FOV is directed generally downward intersecting with at least one of the first FOV or second FOV over the product scanning region.

In additional approaches, the removable scanner further includes an illumination assembly adapted to illuminate a portion of the product scanning region when coupled with the scanner cradle. In implementations, the removable scanner further includes an aiming system and wherein the aiming system is synchronized with the bioptic scanner to prevent imaging of the visual indicator by the first imaging assembly or the second imaging assembly.

In further examples, the removable scanner is a handheld scanner.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a perspective view of an example imaging system, implemented in an example point-of-sale (POS) system, having a bi-optical (also referred to as “bi-optic”) barcode reader having a weigh platter and a removable scanner.

FIG. 2A is a side-view diagram of the barcode reader with a removable scanner of FIG. 1.

FIG. 2B is a front-view diagram of the barcode reader with a removable scanner of FIG. 1.

FIG. 3A is a front perspective view of an industrial digital barcode reader assembly in accordance with this disclosure.

FIG. 3B is a rear perspective view of the industrial digital barcode reader assembly of FIG. 3A in accordance with this disclosure.

FIG. 3C is a side elevation cross sectional view of the industrial digital barcode reader assembly of FIGS. 3A and 3B coupled with a first adapter in accordance with this disclosure.

FIG. 3D is a front perspective view of the industrial digital barcode reader assembly of FIGS. 3A and 3B coupled with a housing in accordance with this disclosure.

FIG. 3E is a front perspective view of the industrial digital barcode reader assembly of FIGS. 3A-3C coupled with a second housing in accordance with this disclosure.

FIG. 4 is a perspective view diagram of a handheld scanner that may be implemented as a removable scanner.

FIG. 5 is a perspective view diagram of barcode reader with a cuboid form factor that may be implemented as a removable scanner.

FIG. 6 is a perspective view diagram of the barcode scanner of FIG. 5 implemented as a removable scanner in an imaging system.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Generally speaking, pursuant to these various embodiments, an example imaging system is provided that includes a removable scanning module that effectively increases an overall field of view (FOV) of the imaging system. The supplemental scanning module is selectively couplable, and may be removed physically from, the imaging system to perform as a handheld or adjustable scanner. The supplemental scanning module may be physically couplable to the imaging system via a scanner cradle, and the system may be configured to synchronize operation of the removable scanning module with other imagers of the imaging system. For example, The removable scanner may be synchronized with other imagers of the imaging system while the removable scanning module is physically coupled to the imaging system, and a controller may control the removable scanning module to operate independently of other imagers of the imaging system when the removable module is physically removed or de-coupled from the imaging system.

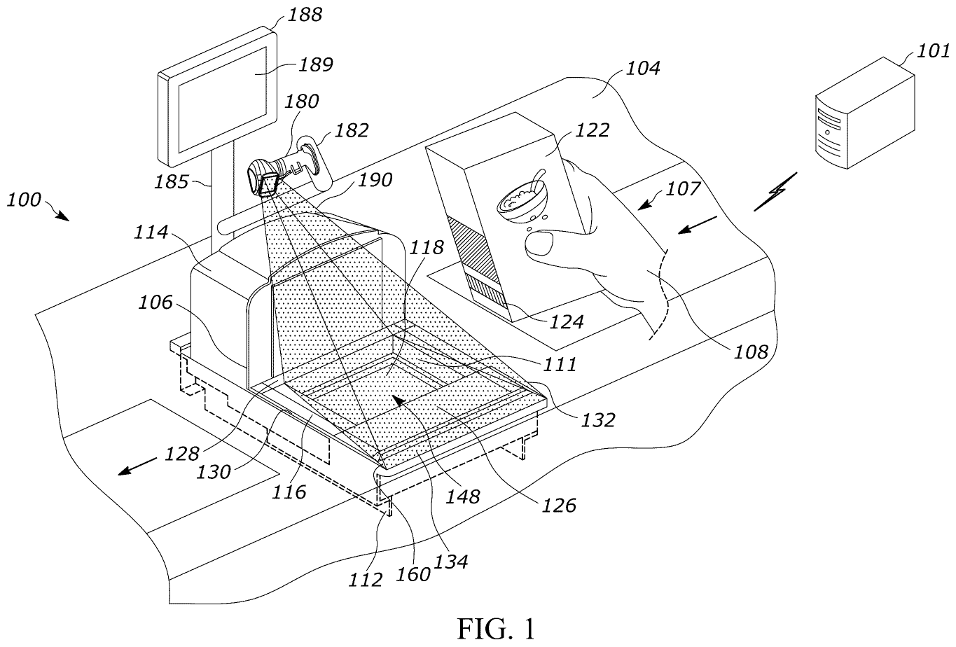

FIG. 1 illustrates a perspective view of an example imaging system capable of implementing operations of the example devices. In the illustrated example, an imaging system 100 is in the form of a point-of-sale (POS) system, having a workstation 102 with a workstation surface (e.g., a counter) 104 and a bi-optical (also referred to as “bi-optic”) barcode reader 106. In the illustrated example, the barcode reader 106 includes an upper housing 114 (also referred to as an upper portion, tower portion, or upper housing portion) and a lower housing 112 (also referred to as a lower portion, platter portion, or lower housing portion). The upper housing 114 is characterized by an optically transmissive window 120 positioned there along a generally vertical plane and a horizontally extending field of view(s) which passes through the window 120. The lower housing 112 is characterized by a weigh platter 111 that includes an optically transmissive window 118 positioned there along a generally horizontal plane and a vertically extending field of view(s) which passes through the window 118. The weigh platter 111 is a part of a weigh platter assembly that will generally include the weigh platter 111 and a scale configured to measure the weight of an object placed on an example surface of a top portion 116, or some portion thereof. While in some instances the weigh platter 111 is fixedly secured to the lower housing 112, in other implementations it is removable by the barcode reader operator. This can be done to, for example, clean under the platter or to replace the platter after wear and tear. As used herein, the term near should at least be interpreted as being within two inches from a given feature. In other implementations, the term near should at least be interpreted as being within one inch, half inch, or quarter inch from a given feature.

In operation, a user 108 generally passes an item 122 across a product scanning region of the barcode reader 106 in a swiping motion in the general direction 107, which in the illustrated example is right-to-left. The product scanning region is illustrated as a region of space in one or more FOVs of the imagers of the system 100 where a target object or barcode may be imaged, scanned, and/or decoded. It should be appreciated that while items may be swiped past the barcode reader 106 in either direction, items may also be presented into the product scanning region by means other than swiping past the window(s). When the item 122 comes into the any of the fields of view of the reader, the barcode 124 on the item 122 is read and decoded by the barcode reader 106 and corresponding data is transmitted to a communicatively coupled host in the for of one or more processor 101. In other instances, items may need to be weighed in order to be added to the ledger of the transaction. In this case, an item is placed on the top surface 116 of the platter 111 for the barcode reader 106 to sense the weight of said item and transmit information associated with this weight to the one or more processors 101. Additionally, image data may be processed for other purposes, such as, for example, potential ticket switching, sweethearting, or other types of shrink-related events. Further to that, image data captured by various imaging assemblies may be used for other purposes like, transitioning from a stand-by mode to a reading mode (i.e., waking up a scanner).

In a preferred embodiment the weigh platter 111 of the barcode reader 106 has various features. Specifically, it includes a central region 126 extending in a transverse plane. In most cases the central region 126 includes a platter window 118 configured to permit light to pass therethrough. This light may both, be emitted from within the lower housing 112 and travel into the interior of the lower housing 112 for capture by various imaging components. The weigh platter 111 further includes a series of edges which, in the illustrated example, include a proximal edge 128 adjacent the upper housing portion 114, a first lateral edge 130 extending non-parallel to the proximal edge 128, a second lateral edge 132 opposite the first lateral edge 130 and extending non-parallel to the proximal edge 128, and a distal edge 134 opposite the proximal edge 128 and extending non-parallel to the first and second lateral edges 130, 132. In the illustrated embodiment, the proximal, lateral, and distal edges form a substantially square shape. However, other shapes are within the scope of this disclosure and the edge arrangement can, for example, result in the weight platter 111 having a substantially rectangular shape whereby lateral edges 130 and 132 are longer than the perpendicularly positioned proximal and distal edges 128 and 134. Similarly, the edge positioning can result in the weigh platter having other regular or irregular shapes.

The barcode reader 106 further includes a removable scanner 180 that is coupled to the upper housing 114 or the lower housing 112 via a scanner cradle 182, and an associated frame member 185. The frame member 185 may include one or more oriented arms that physically couple the cradle 182 and a display 188 to the upper housing 114, lower housing 112, and or other physical elements of the barcode reader 106 or system 100 to support a position and orientation of the removable scanner 180. The one or more processors 101 may control the barcode reader 106 such that when the removable scanner 180 is physically coupled with the bioptic scanner, e.g., via the cradle 182, a controller of a host such as the one or more processors 101 synchronizes operations and/or parameters of the removable scanner 180 with other imagers and elements of the barcode reader, such as imagers of the bioptic scanner, illumination devices, etc., as will be described further herein. The removable scanner 180 has a field of view (FOV) that is generally directed downward and intersecting with at least one other FOV of an imager of the barcode reader 106. In implementations, the supplemental FOV of the removable scanner 180 is generally directed toward the weight platter 111.

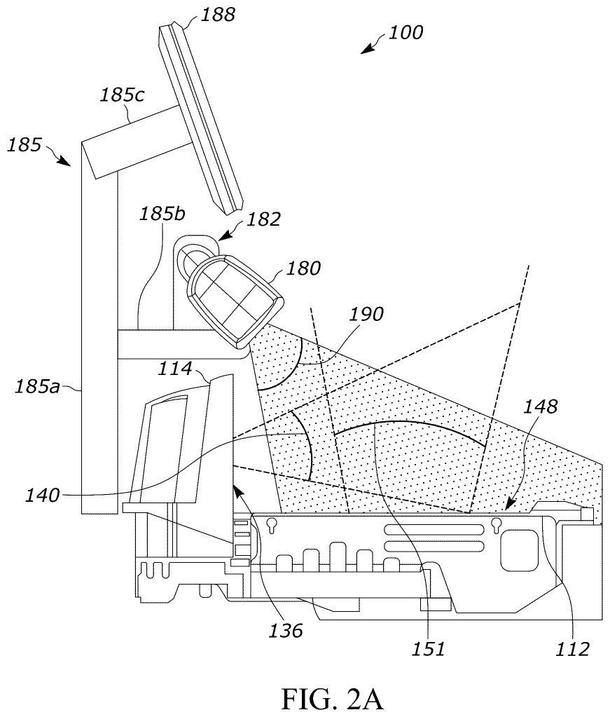

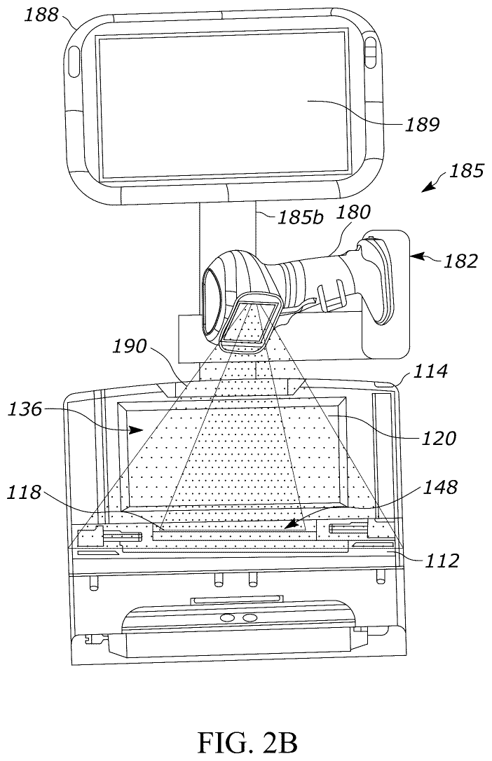

FIG. 2A is a side-view diagram of the barcode reader 106 of FIG. 1, and FIG. 2B is a front-view diagram of the barcode reader 106 of FIG. 1. As described herein, the barcode reader 106 is an adaptable multi-filed of view scanning system with two or more fields of view of a product scanning region. The barcode reader includes a first imaging assembly 136 disposed in the upper housing 114, with the first imaging assembly 136 having a first FOV 140 through the substantially upright window 120. The first imaging assembly 136 may include one or more imaging sensors including one or more solid state devices, for example, a CCD or a CMOS imager, or a camera. The first imaging assembly 136 may include one or more lenses, mirrors, filters, or other optics to direct and focus light onto one or more imaging sensors of the first imaging assembly 136. This image data may be processed by a controller (e.g., by being sent to a decoder) which identifies and decodes decodable indicia captured in the image data. Once the decode is performed successfully, the reader can signal a successful “read” of the target (e.g., a barcode).

In addition to the first imaging sensor, the first imaging assembly 136 can include one or more illumination sources operable to provide light that is directed into the product scanning region through the substantially upright window 120. Under typical conditions, when the imaging sensor is operating to capture light from the product scanning region to produce image data, illumination sources are activated to provide illumination of the target and hence enhance visibility of the target as “seen” by the imaging sensor. In a preferred embodiment, one or more illumination sources comprise a light emitting diode (LED) that is synchronized, at least partially, with the exposure of the imaging sensor.

It should be appreciated that the barcode reader 106 can be configured with one or more primary imaging assemblies that direct various FOVs through the combination of the substantially vertical and substantially horizontal windows 120, 118. To that end, if a single imaging assembly is used, various mirror arrangements can be employed to split the assembly's FOV and direct one portion of that FOV through window 120 and direct another portion of that FOV through windows 118. This can include one or more splitter mirrors and/or one or more folding mirrors whereby the various portions of the FOV can be directed in a desired manner.

Alternatively, and as illustrated, multiple imaging assemblies can be used. For example, the barcode reader 106 can employ a second imaging assembly 148 that is similar in operation to the first imaging assembly 136. That is, the second imaging assembly 148 can include a second imaging sensor along with a respective lens or lens group and one or more illumination sources operable to provide light that is directed into the product scanning region through the substantially horizontal window 118. Under typical conditions, when the second imaging sensor is operating to capture light from the product scanning region over FOV 151 to produce image data, illumination sources are activated to provide illumination of the target and hence enhance visibility of the target as “seen” by the second imaging sensor. In a preferred embodiment, the one or more illumination sources of the second imaging assembly comprise a light emitting diode (LED) that is synchronized, at least partially, with the exposure of the second imaging sensor. It is to be appreciated that any of the imaging assemblies 136, 148 may be in the form of a bioptic scanner, as illustrated in FIGS. 1 and 2A. While described as first and second imaging sensors, in implementations, the first and second imaging sensors may be a same imaging sensor and the first FOV may be imaged and captured on a first portion of the imaging sensor while the second FOV is imaged and captured onto a second portion of the imaging sensor.

While not expressly illustrated, it should be appreciated that the position and orientation of the imaging assemblies disclosed herein are merely provided as examples, and unless otherwise indicated, these assemblies can be positioned anywhere within the upper and lower housing along with any mirrors which allow for any of the one or more FOVs to be redirected in a desired manner. Additionally, independent slot scanners that may provide single FOVs may be used as the barcode reader 106 with the additional removable scanner 180 to provide a supplemental FOV.

The bi-optic barcode reader 106 further includes a removable scanner 180 that is selectively couplable to the cradle. In the illustrated example, the cradle 182 supports the removable scanner 180 in a positioned toward the proximal edge 128, above the upper housing 114. The cradle 182 may further provide power to the removable scanner 180 when the removable scanner 182 is physically disposed in the cradle 182. For example, the cradle 182 may include one or more wired power sources such as via a USB cable, or other power cable, or the cradle 180 may provide power to the removable scanner 180 via inducting charging. The position of the cradle 182 may be adjusted in some implementations to a user preference or for ease of use. For example, the height of the cradle may be adjusted for a user to more easily access the removable scanner 180, or the cradle may be operatively connected to one or more joints for the cradle to be pivoted and repositioned for preferred use by a right-handed user, or a left-handed user. Movement of the cradle for use by differently handed users may allow for a user to more easily grab the removable scanner 180 in certain implementations.

The removable scanner 180 includes at least one supplemental imaging assembly having a supplemental imaging sensor with a supplemental FOV 190 directed toward the product scanning region, as illustrated in FIGS. 2A and 2B. The supplemental FOV 190 of the removable scanner 180 is directed generally downward from the removable scanner 180, and intersects with at least one of the first FOV 140 of the first imager 136, and the second FOV 151 of the second imager 148. Additionally, the removable scanner 180 may include an illumination assembly with one or more illumination sources adapted to provide illumination to a portion of the product scanning region when the removable scanner 180 is disposed in the cradle 182. The removable scanner 180 may further include an aiming system which provides a visual indicator adapted to provide an indication to a user of a direction of the supplemental FOV 190. For example, the aiming system may include one or more LEDs, or laser diodes (LDs) that provide an aiming pattern in the supplemental FOV to provide a user with an indication of a general region of the supplemental FOV 190, and direction the supplemental FOV 190.

A frame 185 includes multiple frame arms 185a, 185b, and 185c to support the cradle 182 and display 188 in position above the upper housing 114. The frame 185 may be physically coupled to the upper housing 114, or another surface of the imaging system 100 to support positions and orientations of elements as described herein. A substantially vertical first arm 185a and be coupled to the upper housing 114 or another surface to allow for a second arm 185b to couple to, with the second arm 185b extending from the first arm 185a to support a position of the cradle 182. In some implementations, one or more arms of the frame 185 may include an interior cavity that houses electronics, data and/or power communication cables, and/or interconnects. The position and the orientation of the cradle 182 may then be adjusted to tune the FOV 190 of the removable scanner 180, when the removable scanner 180 is physically coupled to, or disposed in, the cradle 182. While the illustrated examples depict the removable scanner 180 as a handheld device, other removable scanners or imagers are envisioned, as described further herein. In examples, the cradle 182 may be coupled directly with at least one of the upper housing 114, lower housing 112 via a cradle fixture or support physically coupling the cradle with the upper housing 114 or the lower housing 112.

In some implementations, it may be advantageous to couple the supplemental module 160 with a portion of the lower housing 112 or the frame member 102a as opposed to coupling with the weigh platter 111 to avoid impeding movement of the weigh platter 111. More specifically, in some environments, the weigh platter 111 undergoes a certification to ensure it is providing accurate measurements. In the event that the supplemental module 160 includes wires and/or other components that could interfere with the free-loading nature of the weigh platter 111, mounting the supplemental module 160 to a different component may reduce and/or eliminate such potential interference with weighing accuracy.

The display 188 includes a screen 189 which may display notifications, text, graphics, video, images, or other visuals to a user. The display may provide confirmation of a successful scan and barcode decoding, in additional to providing errors or indications of unsuccessful scans. Additionally, the display may be used for calibrating one or more of the imaging sensors, or other devices of the imaging assemblies, including the removable scanner 180. The display 188 may provide an indication of when the removable scanner 180 is physically coupled to the system via the cradle 182, and when the removable scanner is not coupled to the cradle 182. Additionally, the display 188 may indicate when the removable scanner 180 is being synchronized with one or more other imaging assemblies of the barcode reader 106. The screen 189 of the display 188 may be a touchscreen allowing for a user to provide inputs to the barcode reader 106 for performing any actions or methods described herein.

In implementations, the system 100 includes one or more controllers for controlling operations of the system 110, including the barcode reader 106. The controller may be the processor 101, or the controller may include one or more other processors, networks, or hosts. The controller is operatively coupled to the bioptic scanner, including the first and second imaging assemblies 136 and 148, and the controller is further couplable to the removable scanner 180. The controller is configured to synchronize operations of the removable scanner with the bioptic scanner. For example, the controller may be configured to synchronize the operations of the removable scanner with the bioptic scanner when the removable scanner is physically coupled or disposed in the cradle 182. The controller may synchronize functionalities and configurations of one or more of illumination, image capturing, data transfer processes, an aiming pattern or any other imaging and processing functions.

The controller may be configured to synchronize operations and functions of the removable scanner with at least one of the first imaging assembly 136 and/or the second imaging assembly 148 to obtain images of the product scanning region. For example, the controller may synchronize one or more illumination sources of the removable scanner with one or more imagers of the bioptic system to prevent illumination from the removable scanner being imaged by another imager. Additionally, the controller may turn off any illumination sources of imagers of the bioptic reader when the removable scanner is capturing an image to prevent excess light and image noise from being captured by the removable scanner 180. The controller, such as the processor 101, may control an aiming system of the removable barcode scanner 180 to synchronize operation of the aiming system with imagers of the bioptic scanner. For example, the controller may turn off the aiming pattern or visual indicator (e.g., LED, LD, etc.) while one or more imagers of the bioptic system are obtaining images to prevent imaging of the visual indicator by the first or second imaging assemblies 136 and 148 of the bioptic scanner.

The controller may control imagers of the bioptic scanner and the removable scanner 180 to capture images at a same time, or interleaved depending on specific environments and applications. In applications, the removable scanner 180 may have a same symbol timeout time, which is an amount of time that the removable scanner 180 may decode a same barcode and determine that the barcode has already been scanned, and therefore does not further process the barcode. As such, the removable scanner 180 is prevented from processing a same barcode more than once causing potential erroneous scans or repeat scans of a same barcode or item. In examples, the controller may coordinate or synchronize the same symbol timeout time of the removable scanner 180 with a same symbol timeout time of the bioptic scanner to prevent a same barcode from being decoded and processed by one or more imagers of the bioptic scanner and the removable scanner 180. This allows for independent imaging of a same symbol or barcode, without erroneously decoding the same barcode by different scanners of the bioptic scanner and removable scanner 180. Additionally, the controller may control other parameters and operations of the bioptic scanner and removable scanner 180 such as one or more resolutions, illumination brightnesses, etc. Additionally, synchronizing operations and parameters may include performing operations simultaneously, sequentially, partially overlapped in time, interleaved, and/or not performing an operation due to one or more other operations being performed.

Synchronizing operations may include synchronizing or coordinating one or more indications provided by the system 100. For example, a beep, visible flash, light color change, or other audio or visual indication provided by a speaker, display, LED, etc. may provide an indication that an item has been successfully scanned, or has not been successfully scanned. In example, the controller may synchronize one or more output devices to provide a single indication for successful or unsuccessful scans, or an indication, rather than multiple indications being provided. Synchronizing and coordinating audio and visual indications and outputs may reduce confusion of a user operating the system 100. Alternatively, various indications may be provided independently when the removable scanner 180 is not coupled with the scanner cradle 182. Synchronizing operations may further include synchronizing and coordinating decode payloads during barcode decoding. When the removable scanner 180 is not coupled with the cradle 182, the decode payload may be directly communicated to a host such as the processor 101 for further processing and use. When the removable scanner 180 is not coupled with the cradle 182, a single decode payload scanned by one of the imagers 13136, and 148 or the removable scanner 180 is provided to a host for further use and decoding. As such, the removable scanner independently may provide decode payload information to a host when not coupled with the cradle 182, and may perform in coordination or synchronization with other imagers to provide decode payload information when coupled with the cradle 182. In examples, images of the supplemental FOV 190 may be combined with images of other FOVs to stitch together one or more images to perform barcode decoding or identify and decode indicia.

The removable scanner 180 may enter different modes of operation depending on whether the removable scanner 180 is physically coupled to the cradle 182. For example, the removable scanner 180 may enter a synchronized mode when physically coupled to the cradle 182, and an independent mode when the removable scanner is not physically coupled to the cradle 182. In the synchronization mode, the removable scanner 180 may be controlled by the controller to synchronize one or more operations, as described herein, of the removable scanner 180 with operations of the bioptic reader to obtain images of one or more objects in the product scanning region. In independent operation mode, the controller does not synchronize operations of the removable scanner with the bioptic reader, and therefore, the removable scanner 180 controls its operations according to its own independent operation mode settings and parameters (e.g., frame rate, illumination source brightness, illumination on/off time, image capture rate, image capture time, etc.). As such, removable scanner 180 controls its own operations in independent operation mode, and the controller controls one or more operations and/or parameters of the removable scanner 180 when the removable scanner 180 is in synchronization mode. In implementations, the processor 101 may control the removable scanner 180 to cause the removable scanner 180 to enter the synchronization and independent operation modes, or the removable scanner may be configured to enter the synchronization and independent operation modes itself with an internal processor or controller. In independent operation mode, the removable scanner 180 may be used as a vision camera that provides images and video to a video processing module, such as one or more processors 101, for perform machine vision operations.

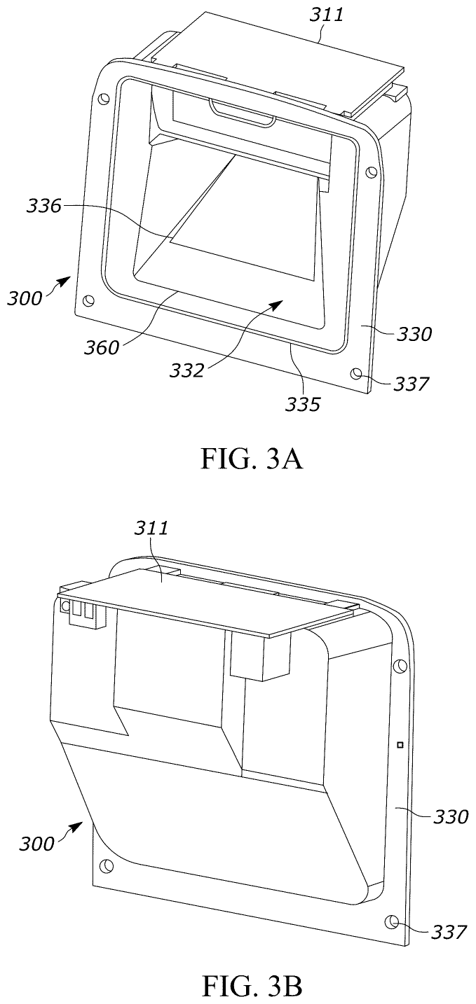

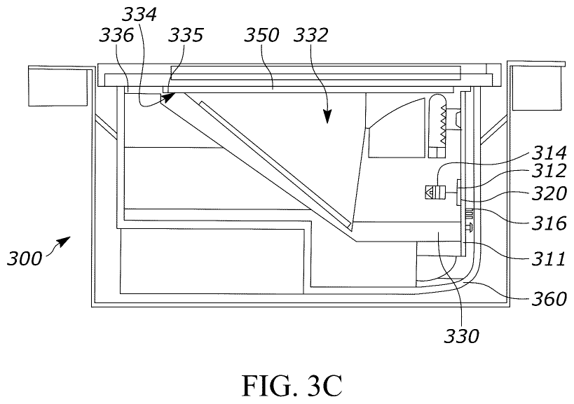

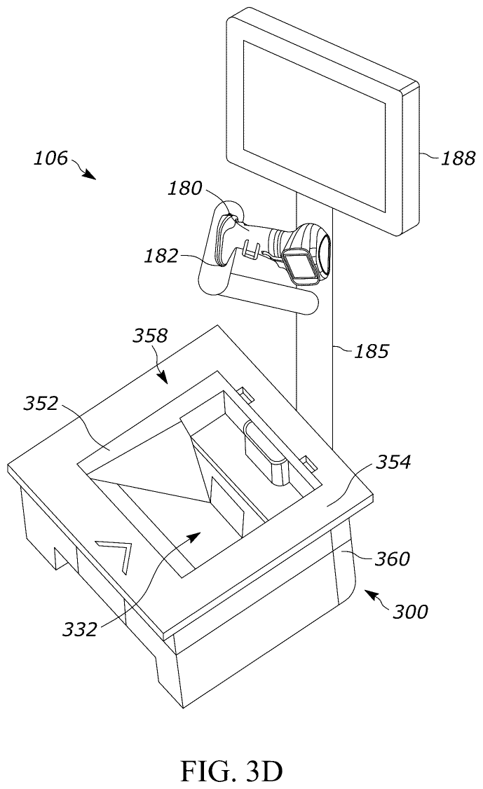

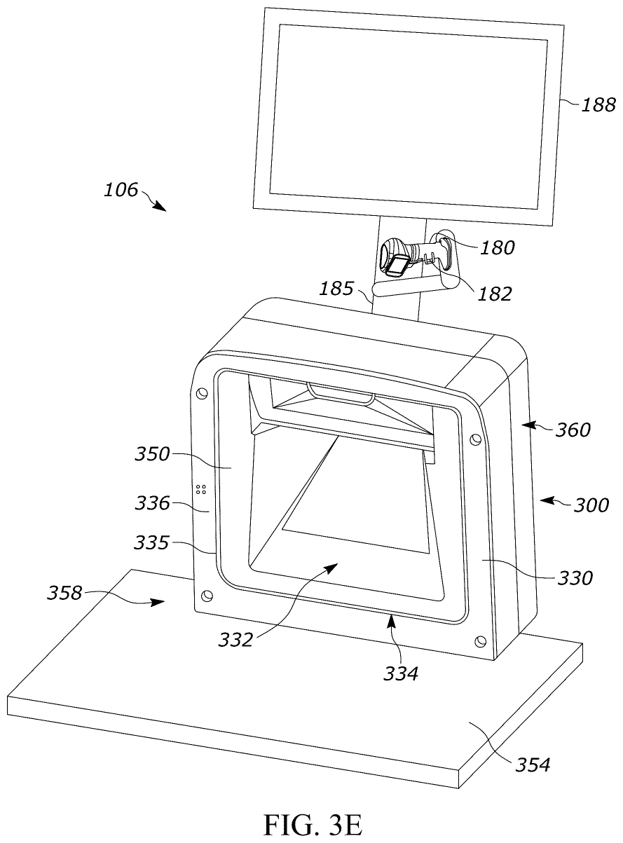

While illustrated in FIGS. 1, 2A, and 2B as a bioptic scanner, the barcode reading with a removable scanner may be implemented with a slot scanner. FIGS. 3A and 3B are diagrams of front and rear perspective views of an industrial slot scanner assembly, respectively, that may be implemented in the barcode reader 106 of FIG. 1. FIG. 3C is a side elevation cross sectional view of the industrial digital barcode reader assembly of FIGS. 3A and 3B coupled with a first adapter in accordance with this disclosure. FIGS. 3C and 3D are perspective view diagrams of the barcode reader 106 with slot scanners according to FIGS. 3A and 3B, with the removable scanner 180. Across each of FIGS. 3A-3D, reference numeral 300 generally identifies a convertible slot scanner assembly for capturing at least one image of an object appearing in a field of view (FOV). The convertible slot scanner assembly 300 includes a circuit board 311, an imaging assembly 312, a controller 316, an image decoder 320, a chassis 330, a first window 350, and a housing 360.

The chassis 330 is configured to accommodate all of the opto-mechanics such as the imaging assembly 312, the controller 316, and the image decoder 320, and includes an optical cavity 332, an opening 334, a flange 336 that at least partially surrounds the opening 334, and a mirror support surface. The flange 336 may act as a seal to seal the entire perimeter of the housing 360. The system assembly may include a seal member such as a gasket (not illustrated) to further seal the housing 360 and to create a dust seal and/or an electrostatic discharge seal. The chassis 330 may be constructed from any number of suitable materials such as, for example, metals and/or polymers. Notably, by using the chassis 30 to mount the opto-mechanics separately from the housing 360, the assembly 300 may be used in kiosk applications where the assembly 300 does not need the additional housing, thereby reducing costs.

In the illustrated example, the opening 334 further defines a supporting ledge or recess 335. Further, the flange 336 may include any number of mounting features 337 (e.g., holes) to accommodate mounting of the chassis 330 as will be described in further detail below.

The optical cavity 332 is a generally hollow region that allows light to pass through to the imaging assembly 312. The chassis 330 includes a mounting portion 338 (e.g., a generally flat surface) that accommodates the circuit board 311 by securing the circuit board 311 thereto via any number of suitable approaches. The imaging assembly 312, the controller 316, and the image decoder 320 may all be operably coupled with the circuit board 311 via any number of suitable approaches. The imaging assembly 312 is configured to capture an image frame appearing in a FOV and can include any number of image sensors 314. The image sensor 314 has a plurality of photosensitive elements. The decoder 320 is communicatively coupled with the imaging assembly 312 and is configured to decode a barcode captured in an image by the imaging assembly 312. In some examples, only the imaging assembly 312 is communicatively coupled to the decoder 320 and is used to process images for decoding indicia.

With reference to FIG. 3D, the housing 360 may include a housing cavity dimensioned to at least partially accommodate the chassis 330. The housing 360 may generally be in a horizontal position relative to a scanning surface 354 that may be at the top of the horizontally oriented housing. The image sensor in the horizontal housing has a FOV generally aimed through the window 352 toward a product scanning region 358. FIG. 3E is a diagram of a perspective view of the slot scanner assembly 310 in a vertical housing configuration. The housing 360 may be in a generally vertical orientation relative to a scanning surface 354. The image sensor of the slot scanner in the vertical housing has a FOV generally aimed through the window 350 toward the product scanning region 358. Each of the horizontal and vertical configuration slot scanner barcode readers in FIGS. 3D and 3E further includes the removable scanner 180 and display 188. The removable scanner 180 and display 188 are supported in position by one or more frames 185 that are physically coupled to the housing 360, or another surface or element. The removable scanner 180 is disposed in the cradle 185 to position the removable scanner to have a supplemental FOV as described herein. In the horizontal configuration of FIG. 3D, the supplemental FOV of the removable scanner 180 is generally directed downward through the product scanning region 358 toward the window 352. In the vertical configuration of FIG. 3E, the removable scanner 180 has a supplemental FOV directed toward the product scanning region 358 and a scanning surface 354 and away from the window 350. The supplemental FOV of the removable scanner 180 in the vertical configuration is not generally directed toward the window 350 and the vertical housing 360 is below the removable scanner 180 on a same side of the product scanning region 3358 as the removable scanner 180.

As illustrated in FIGS. 3D and 3E the housing 360 may be operably coupled with different adapters for selectively positioning the slot scanner assembly 310 in horizontal and vertical configurations. In horizontal configurations, the slot scanner assembly 310 may be disposed within a countertop where the scanner assembly 310 may be a part of a conveyor or similar checkout environment. In vertical configurations, the slot scanner assembly 310 may be used in kiosks, or countertop environments. The removable scanner 180 may be physically coupled top each scanner in the horizontal and vertical configurations via a cradle 182 which may also be physically coupled via one or more frames 185.

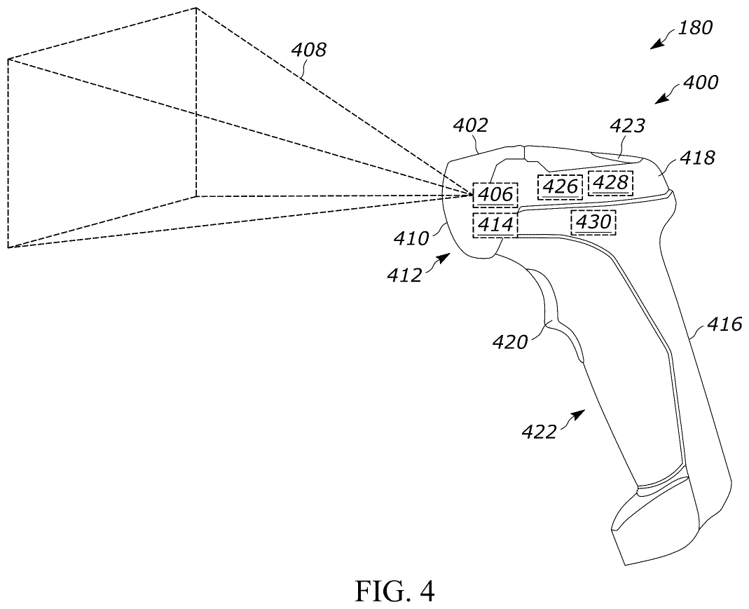

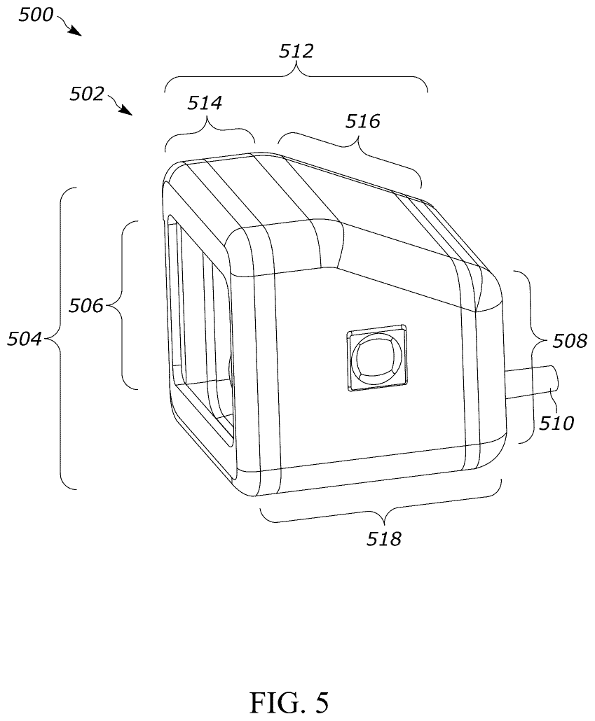

In examples, the removable scanner 180 may be a handheld scanner. FIG. 4 is a perspective view diagram of a handheld scanner that may be implemented as the removable scanner 180 of FIGS. 1, 2A, 2B, 3D, and 3E. FIG. 4 illustrates an example handheld scanner 400 that may be used as the removable scanner 180. The handheld scanner 400 is configured to, among possibly other things, scan and decode indicia, such as a barcode, direct product marking (DPM), or the like. The example handheld scanner 400 includes an example housing 402 in which an image sensor 406 is disposed. The image sensor 406 captures image data representing a target in a field of view 408 of the handheld scanner 400 that passes through a front-facing opening or window 410 on a front side 412 of the handheld scanner 400. The handheld scanner 400 includes an indicia decoder 414 in communication with the image sensor 406, and configured to receive the image data and decode an indicia captured in the image data.

The example housing 402 of FIG. 4 includes a generally elongated handle or lower handgrip portion 416, and an upper body portion 418 having the front side 412 at which the light-transmissive window or opening 410 is located. The cross-sectional dimensions and overall size of the handgrip portion 416 are such that the handheld scanner 400 can be conveniently held in an operator's hand. The front-facing opening or window 410 is configured to face generally away from a user when the user has the handheld scanner 400 in a handheld position. The portions 416 and 418 may be constructed of a lightweight, resilient, shock-resistant, self-supporting material, such as a synthetic plastic material. The housing 402 may be injection molded, but can also be vacuum-formed or blow-molded to form a thin hollow shell which bounds an interior space whose volume is sufficient to contain the various components of the handheld scanner 400. Although the housing 402 is illustrated as a portable, point-of-transaction, gun-shaped, handheld housing, any other configuration including a hands-free configuration could be used. For example, the housing 402 may be configured or shaped to be disposed in a cradle as described herein, and operation of the handheld scanner 400 may be synchronized with one or more other imaging assemblies for performing imaging, barcode decoding, and machine vision processes.

A manually actuatable trigger 420 is mounted in a moving relationship on the handgrip portion 416 in a forward facing region 422 of the handgrip portion 416. An operator's finger can be used to actuate (e.g., depress) the trigger 420 once a target falls within the imaging field of view 408 to cause the image sensor 406 to capture an image of the target.

To provide one or more indications (e.g., steady indication light indicating the handheld scanner 400 is powered on, a blinked indication light indicating an indicia has been decoded, etc.), the handheld scanner 400 includes one or more example indicator windows 423 defined in the housing 402. The indicator window(s) 423 are positioned to face at least one of rearwardly, upwardly, or sidewardly relative to the front-facing window or opening 410, and towards a user such that the indicator window(s) 123 are generally visible to the user while the user has the handheld scanner 400 in the handheld position.

To generate light to be emitted through the indicator window(s) 423 as indication light, the handheld scanner 400 includes one or more light sources (one of which is designated at reference numeral 426) disposed inside the housing 402 and positioned to emit indication light through a respective indicator window 123. The light source(s) 426 may be, or include, one or more light-emitting diodes, a light pipe, etc. To provide different indication lights through a particular window 423 there may be more than one light sources 426 association with that window 423.

To use a reflection of indication light emitted through an indicator window 423 and/or ambient light as a trigger or control input, the example handheld scanner 400 includes one or more light detectors (one of which is designated at reference numeral 428) disposed inside the housing 402 for respective ones of the indicator windows 423. The light detector(s) 428 are positioned to detect a reflection of emitted indication light received from an object positioned in front of or on a respective window 423 (e.g., a thumb n object to be scanned, etc.) wherein the reflection of the emitted indication light occurs when the object (e.g., a finger, thumb, target object, barcode, etc.) is positioned in front of or on the window 423 outside the housing 402. In some examples, a light detector 428 includes a photodetector and a filter (not shown for clarity of illustration) that blocks wavelengths of light not associated with emitted indication light. For example, if emitted indication light is either green or red, then a filter could block reflected light having other colors.

The example handheld scanner 400 includes a processor 430 configured to control one or more operations and/or modes of the handheld scanner 400 and/or a device in communication with the handheld scanner 400 (e.g., a point-of-sale (POS) station, an inventory management system, etc.). While described previously as controlled by the controller, the processor 430 may control the mode of the handheld scanner 400 to be in a synchronized mode, or an independent operational mode. For example, the processor 430 may determine, via one or more sensors, images, communications with other systems, etc. that the handheld scanner is disposed in and/or physically coupled with a cradle, such as the cradle 182. The processor 430 may then control the handheld scanner 400 to enter the handheld scanner 400 into a synchronized mode to synchronize operations and properties of the handheld scanner 400 with one or more imaging assemblies, and other elements of imagers, of the imaging system. When the handheld scanner 400 is removed from the cradle 182, the processor may control the handheld scanner 400 to enter into the independent operation mode where the handheld scanner performs operations independently of imaging of other imaging assemblies and systems.

While previous described and illustrated as a handheld scanner, the removable scanner 180 of FIGS. 1, 2A, 2B, 3D, and 3E may further be another type of removable scanner, such as a handheld cuboid barcode reader. FIG. 5 is an exemplary barcode reader 500, with a cuboid form factor that may be implemented as the removable scanner 180. The barcode reader 500 includes an imaging assembly (not shown) and a housing 502 containing the imaging assembly. As shown in FIG. 5, the housing 502 of the imaging assembly is generally cuboid in shape with six sides. For instance, the general shape of the housing 502 may be a cube or a prism (e.g., a rectangular prism, a trapezoidal prism, etc.) Of course, the housing 502 is not necessarily a perfect cube or a perfect prism in all embodiments. For instance, edges and/or corners of the housing 502 may be rounded to allow for a comfortable grip by a user.

In particular, one of the sides 504 of the housing 502 contains an opening 506 (e.g., a window) through which the imaging assembly captures images (e.g., images of barcodes for scanning). Generally speaking, when the imaging assembly is a one-dimensional imaging assembly, the field of view (FOV) of the imaging assembly extends along one or more horizontal planes passing through the opening 506. Of course, when the imaging assembly is a two-dimensional imaging assembly, the FOV also extends along one or more vertical planes through the opening 506. For example, the FOV of the imaging assembly may be designed to fill the opening 506. Opposite the opening 506, a side 508 of the housing 502 may include a communication connector 510 configured to receive a communication cable through an aperture the side 508, e.g., for powering the imaging assembly and/or for transmitting captured images externally. The communication connector 510 may physically coupled with a port (e.g., USB, etc.) in a cradle for synchronizing operation of the barcode reader 500 with another imaging assembly or system, as described herein. Further, the communication connector 510 may further couple to one or more power sources to provide power to the barcode reader 500.

The size of the housing 502 advantageously allows the housing 502 to be easily picked up by users as needed. The width of the opening 506 is generally greater than 1.5 inches. This wide opening ensures that even the widest codes can be easily read. Moreover, generally speaking, each of the sides are flat and may be used as mounting/attachment surfaces or for ease of fitting into a cradle. Each of the six sides of the housing 502 may include multiple non-parallel portions. For instance, the side 512 shown in FIG. 5 includes two such portions 514 and 516. Generally speaking, the housing 502 is substantially stable when a side (or a portion of a side) that is parallel to one of the horizontal FOV planes passing through the opening 506 of the housing 502 is placed on a flat surface or physically disposed in a cradle. In some examples, the horizontal planes include a central horizontal plane, and the housing 502 is substantially stable when a side or portion of a side that is substantially parallel to the central horizontal plane is placed on a flat surface or disposed in a cradle. For instance, the housing 502 may be substantially stable when side 518 is placed on a flat surface.

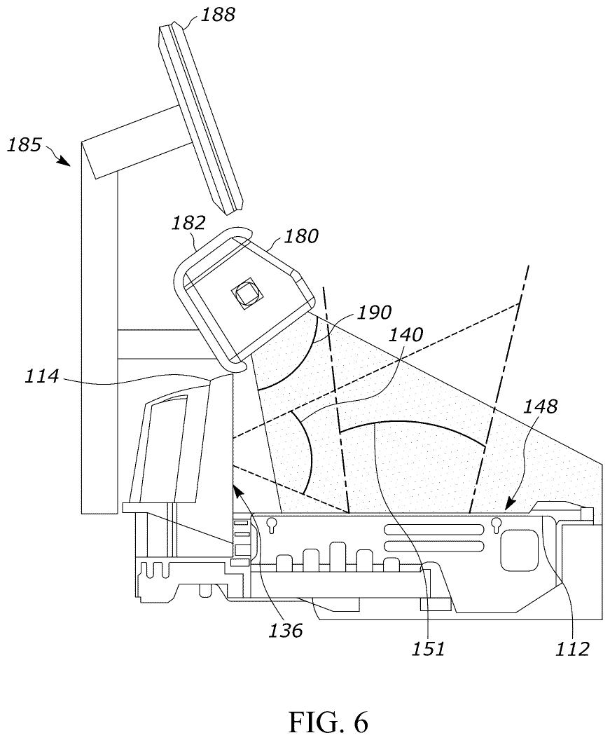

FIG. 6 is a perspective view diagram of the barcode scanner 502 of FIG. 5 as a removable scanner 180 of the system 100 and barcode reader 106 of FIGS. 1, 2A, 2B, 3D, and 3E. The barcode reader 106 includes the upper housing 114 and lower housing 112. The first imaging assembly 136 is disposed in the upper housing 114 with a first FOV 140 through a window of the upper housing 114. The second imaging assembly 148 is disposed in the lower housing 112 with a second FOV 151 through a window of the second housing 112 and toward a product scanning region, as described with reference to FIG. 2A. One or more frames 185 physically support a display 188, and the cradle 182. The removable scanner 180, in the form of the cuboid scanner 502 of FIG. 5, is selectively couplable with the cradle 182. The one or more processors 101, or a processor in the removable scanner 180, controls the removable scanner to operate in a synchronized mode, or an independent operations mode. When the removable scanner 180 is disposed in the cradle 182, the controller controls the removable scanner 180 to synchronizes operations and parameters with the first and/or second imaging assemblies 136 and 148 of the barcode reader 106. When the removable scanner 180 is removed from the cradle 182, the controller controls the removable scanner 180 to perform operations, and have parameter settings independent of operation and imaging of any other imaging assemblies. While disposed in the cradle 182, the removable scanner 180 provides a supplemental FOV 190 of the product scanning region, as previously described. A user may remove the removable scanner 180 from the cradle 182 to manually move and manipulate to removable scanner 180 to scan an object or barcode independent of imaging and scanning performed by the first and second imaging assemblies 136 and 148.

It should be appreciated what any of the image sensors noted in this disclosure can be either monochrome or polychrome (i.e., colored). In implementations where polychrome image sensors are implemented, object recognition capabilities may be realized to assist with desired retail considerations.

While each of the imaging assemblies disclosed herein may include similar or identical components, data received from each of the assemblies may be processed in accordance with respectively predefined criteria. For example, image data received from imaging assemblies 136, 148, and image sensor 406 may be processed primarily for the detection and decoding of barcodes that may appear within the respective FOVs. While this may be an objective of image analysis coming from these assemblies, this should not be interpreted as limiting and image data from these assemblies can further be used for object and/or object characteristic detection. Additionally, image data received from any of the image assemblies can be in a form of singular images, image sets, or video streams comprising a plurality of images. It should also be appreciated that the processing of the data from these assemblies can occur via different physical and/or logical pipelines. For example, processing of image data obtained from the first or second imaging assemblies 136, 148 may be processed through a first processing pipeline, and the processing of image data obtained from the removable scanner 180 may be processed through a separate processing pipeline. In such examples, the second processing pipeline may be at least partially implemented within the removable scanner 180 itself and may include non-barcode decoding vision operations (e.g., the processing of image data for the detection of an item). These modules can be logically different or they may be implemented on separate hardware components.

So arranged, the multi-directional orientation of the various FOVs of a barcode reader described herein can also be advantageously used to render an at-least partial three-dimensional representation of an item presented in the product scanning region of the barcode reader 106 and/or determine a dimension associated with the item presented in the product scanning region of the barcode reader 106. This can be done in accordance with the processing criteria described above. The optical arrangements described here provide for a robust system to read codes facing in multiple directions depending on how the field of use is oriented. The removable scanner 180 provides additional FOV that may increase the overall FOV of a barcode reader in a retrofit manner. In some arrangements, the removable scanner 180 may include components to provide for a “plug-and-play” arrangement whereby power and/or data transmission may be quickly initiated via the use of electronic couplings and/or connectors. The removable scanner 180 may include instructions for synchronizing with imaging assemblies of a bioptic scanner, slot scanner, or other imaging assemblies.

It is to be appreciated that in some examples, the imaging system 100 may include any number of additional features to assist with usability. For example, in some embodiments, the barcode reader 106 can be connected to or include a point-of-sale user interface (POSUI). The POSUI can be communicatively coupled to the barcode reader 106 and can be generally positioned at or near the upper housing portion 114. The POSUI can include devices like a display (touchscreen or passive), keyboard, credit-card processing device, and the like. In some examples, the system 100 may include any number of indicators to improve usability. For example, a visual indicator may be provided that directs a user towards the product scanning region. In some examples, such a visual indicator may be in the form of a marking (e.g., an etching, a label, and the like) disposed on or near the weigh platter 111. In other examples, the removable scanner 180 may provide a visual indicator of a region of the supplemental FOV 190, or generally indicating a direction or region of the supplemental FOV 190. Other examples are possible.

The system 100 may include any number of additional indicators such as, for example, a decoding indicator that provides an indication of which imaging assembly 136, 148, and/or image sensor 406 captured an image of the item 122. For example, a light pattern or an audible indicator may be provided having unique visual and/or audible indicators associated with each imaging assembly to convey information about which imaging assembly decoded the barcode and/or otherwise captured an image. In other examples, each imaging assembly may have a light positioned in close proximity thereto that may illuminate when the specific imaging assembly captures an image. The system 100 may additionally track such image capture events to assist with determining how users engage the workstation 102 to scan products.

Having image data from the various orientations disclosed herein can be advantageously used to detect shrink events. For example, a shrink event can be identified by (i) processing image data from the image assemblies 136, 148 to identify an item identifier based on an indicia (like a barcode) present in the first image data, (ii) processing the image data from the removable scanner 180 to identify an item characteristic based on a physical appearance of the item present in that data, and (iii) detecting a mismatch between the item identifier and the item characteristic. Similarly, image data from the imaging assemblies 136, 148, and image sensor 406 can be processed to detect movement within the product scanning region during a timeframe, identify a lack of a decodable indicia being present in the image data during the timeframe, and identify an item being present in the scanning region during the timeframe. Such event can again signal a potential shrink event as an item has been passing through a product scanning region without being added to a transaction log.

The above description may refer to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions.

As used herein, each of the terms “tangible machine-readable medium,” “non-transitory machine-readable medium,” “computer-readable media,” “computer-readable storage medium,” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

We claim:

1. A barcode reader comprising:
a bioptic scanner including:
(a) a housing having (i) a first housing portion with a first surface and a first window facing a product scanning region, (ii) a second housing portion with a second surface and a second window facing the product scanning region;
(b) a first imaging assembly having a first imaging sensor, the first imaging assembly having a first field of view (FOV) directed through the first window; and
(c) a second imaging assembly having a second imaging sensor, the second imaging assembly having a second FOV directed through the second window;
a removable scanner module selectively couplable with a scanner cradle coupled with at least one of the first housing portion, the second housing portion, or a frame member, the removable scanner module including at least one supplemental imaging assembly having a supplemental imaging sensor with a supplemental FOV directed toward the product scanning region; and
a controller operatively coupled to the bioptic scanner and couplable to the removable scanner module, the controller configured to synchronize the removable scanner module with the bioptic scanner.

2. The barcode reader of claim 1 wherein, when coupled with the scanner cradle, the controller synchronizes the removable scanner module with the bioptic scanner by synchronizing one or more of illumination, image capturing, data transfer processes, and an aiming pattern.

3. The barcode reader of claim 1, wherein, when coupled with the scanner cradle, the controller synchronizes the removable scanner module with at least one of the first imaging assembly and the second imaging assembly to obtain images of the product scanning region.

4. The barcode reader of claim 1, wherein the removable scanner module has a same symbol timeout time, and wherein the controller coordinates the same symbol timeout time of the removable scanner module with a same symbol timeout time of the bioptic scanner.

5. The barcode reader of claim 1, wherein, when coupled with the scanner cradle, the supplemental FOV is directed generally downward intersecting with at least one of the first FOV or second FOV over the product scanning region.

6. The barcode reader of claim 1, wherein, when the removable scanner module is coupled with the scanner cradle, the scanner cradle module is configured to provide power to the removable scanner.

7. The barcode reader of claim 1, wherein the removable scanner is powered by a wired power source.

8. The barcode reader of claim 1, wherein the cradle is repositionable to support use by various users.

9. The barcode reader of claim 1, further comprising a weight platter configured to support an object for obtaining a weight of the object in the product scanning region and wherein the supplemental FOV is directed toward the weight platter.

10. The barcode reader of claim 1, wherein, when coupled with the scanner cradle, the removable scanner module enters a synchronization mode and when decoupled from the scanner cradle, the removable scanner module enters an independent operation mode.

11. The barcode reader of claim 10, wherein in the synchronization mode, the controller synchronizes one or more operations of the removable scanner module with the bioptic scanner to obtain images of an object disposed in the product scanning region, and in the independent operation mode, the controller does not synchronize the removable scanner module with the bioptic scanner to obtain images.

12. The barcode reader of claim 1, wherein the removable scanner module further comprises an illumination assembly adapted to illuminate a portion of the product scanning region when coupled with the scanner cradle.

13. The barcode reader of claim 1, wherein the removable scanner module further comprises a visual indicator adapted to indicate a direction of the supplemental FOV.

14. The barcode reader of claim 13, wherein the visual indicator comprises an aiming system.

15. The barcode reader of claim 14, wherein the aiming system is synchronized with the bioptic scanner to prevent imaging of the visual indicator by the first imaging assembly or the second imaging assembly.

16. The barcode reader of claim 1, wherein the first imaging sensor and the second imaging sensor are a same imaging sensor, and the first FOV is captured on a first portion of the imaging sensor, and the second FOV is captured on a second portion of the imaging sensor.

17. An adaptable multi-field of view scanning system, the system comprising:
a bioptic scanner including:
(a) a housing having (i) a first housing portion with a first surface and a first window facing a product scanning region, (ii) a second housing portion with a second surface and a second window facing the product scanning region;
(b) a first imaging assembly having a first imaging sensor, the first imaging assembly having a first field of view (FOV) directed through the first window; and
(c) a second imaging assembly having a second imaging sensor, the second imaging assembly having a second FOV directed through the second window;
a removable scanner module selectively couplable with a scanner cradle coupled with at least one of the first housing portion, second housing portion, or a frame member, the removable scanner module including at least one supplemental imaging assembly having a supplemental imaging sensor with a supplemental FOV directed toward the product scanning region, and wherein, when coupled with the scanner cradle, the removable scanner module is in synchronization with the bioptic scanner;
one or more processors configured to control a mode of the removable scanner module or a device in communication with the removable scanner module in response to coupling of the removable scanner module with the scanner cradle; and
a computer-readable storage medium storing computer-readable instructions that, when executed by one or more processors, cause the processor to (i) configure the removable scanner module into a synchronize mode when the removable scanner module is coupled to the scanner cradle and (ii) configured the removable scanner module into an independent operation mode when the removable scanner module is not coupled to the scanner cradle.

18. The scanning system of claim 17, wherein, in synchronize mode, the computer-readable media cause the one or more processors to synchronize the removable scanner module with at least one of the first imaging assembly and the second imaging assembly to obtain images of the product scanning region.

19. The scanning system of claim 17, wherein the removable scanner module has a same symbol timeout time, and wherein the computer readable media causes the one or more processors to synchronize the same symbol timeout time of the removable scanner module with a same symbol timeout time of the bioptic scanner.

20. The scanning system of claim 17, wherein, when coupled with the scanner cradle, the supplemental FOV is directed generally downward intersecting with at least one of the first FOV or second FOV over the product scanning region.

21. The scanning system of claim 17, wherein the bioptic scanner further comprises a weight platter configured to support an object for obtaining a weight of the object in the product scanning region and wherein the supplemental FOV is directed toward the weight platter.

22. The scanning system of claim 17, wherein the removable scanner module further comprises an illumination assembly adapted to illuminate a portion of the product scanning region when coupled with the scanner cradle.

24. The scanning system of claim 22, wherein the removable scanner module further comprises an aiming system and wherein the aiming system is synchronized with the bioptic scanner to prevent imaging of the visual indicator by the first imaging assembly or the second imaging assembly.

24. The scanning system of claim 22, wherein the removable scanner comprises a handheld scanner.

25. A barcode reader comprising:
a slot scanner including:
(a) a housing having a first housing portion with a first surface and a first window facing a product scanning region;
(b) a first imaging assembly having a first imaging sensor, the first imaging assembly having a first field of view (FOV) directed through the first window;
a removable scanner module selectively couplable with a scanner cradle coupled with at least one of the first housing portion or a frame member, the removable scanner module including at least one supplemental imaging assembly having a supplemental imaging sensor with a supplemental FOV directed toward the product scanning region; and
a controller operatively coupled to the bioptic scanner and couplable to the removable scanner, the controller configured to synchronize the removable scanner with the bioptic scanner.

26. The barcode reader of claim 25, wherein the first window is substantially horizontal and underneath the product scanning region, the first FOV is generally directed upward toward the product scanning region, and, when the removable scanner is coupled with the scanner cradle, the supplemental FOV is generally directed downward through the product scanning region toward the first window.

27. The barcode reader of claim 25, wherein the first window is substantially vertical, the first FOV is generally directed horizontally toward the product scanning region, and, when the removable scanner is coupled with the scanner cradle, the supplemental FOV is generally directed downward through the product scanning region away from the first window.
